(19) United States
(12) Patent Application Publication
(10) Pub. No.: US 2002/0069414 A1
(43) Pub. Date: Jun. 6, 2002

(54) Method for re-utilizing contents data for digital broadcasting and system therefor

(75) Inventor: Moon-Young Kim, Kyungki-do (KR)

Correspondence Address: MERCHANT & GOULD PC, P.O. BOX 2903, MINNEAPOLIS, MN, 55402-0903, US

(73) Assignee: ALTICAST, CORP.

(21) Appl. No.: 10/004,922

(22) Filed: Dec. 4, 2001

(30) Foreign Application Priority Data
Dec. 4, 2000 (KR) 10-2000-73040

(51) Int. Cl. G06F 3/00; H04N 5/445

(52) U.S. Cl. 725/51

(57) ABSTRACT

A method for re-utilizing contents data for a digital television using an Internet network and a system therefor are provided. The contents data transmitted from a digital broadcast network is received by the tuner of a server, is stored in a database, and is re-edited if necessary. The edited contents data is transmitted to the computer terminal of a user through the Internet network. The user views the contents data for digital broadcasting using the computer terminal. The server receives the contents data through the digital broadcast network, divides the received contents data by broadcast channels, stores the divided contents data in the database, and transmits the stored contents data to the user through the Internet network. The user terminal receives the contents data through the Internet network, divides the received contents data into video data, audio data, and information data, decodes the divided video and audio data by a video decoder and an audio decoder, interprets and synchronizes the information data, and outputs the information data. Accordingly, the user re-utilizes the contents data for digital broadcasting.

### BACKGROUND OF THE INVENTION

1. Field of the Invention

The present invention relates to a method for re-utilizing contents data for a digital television using an Internet network and a system therefor.

2. Description of the Prior Art

A broadcasting station can digitally modulate and transmit various information items related to a broadcast program as well as an image and a voice in digital broadcasting, unlike in analog broadcasting. That is, broadcasting environment changes to thus meet various needs of viewers by digitalizing broadcasting so that information related to the image and the voice is transmitted together with the broadcast program.

However, the number of digital television broadcasting stations rapidly increases since television broadcasting is digitalized. Accordingly, a great amount of information is provided to the viewers. In such environment, it is difficult for the viewers to select desired information. Also, the viewers cannot view broadcasting at any time desired by the viewers due to the restricted bandwidth of a broadcasting radio wave. It is difficult for the viewers to view desired broadcasting when broadcast programs to be viewed are provided by various channels and the broadcasting times of the programs overlap each other.

Also, it is difficult to re-utilize the information of a once-broadcast program since it is difficult for the viewers to manage large amounts of digital broadcasting programs provided by the respective broadcasting stations.

### SUMMARY OF THE INVENTION

Accordingly, it is an object of the present invention to provide a method for re-utilizing contents data for digital broadcasting, which is capable of letting viewers view broadcast programs desired by the viewers and obtain information related to the programs regardless of time and places and select more programs in digital broadcasting, and a system therefor.

To achieve the above object of the present invention, there is provided a method for re-utilizing contents data for digital broadcasting, comprising the steps of (a) receiving and editing contents data from a digital broadcast network and (b) receiving the edited contents data through an Internet network and viewing the received contents data. The step (a) comprises the steps of (a1) receiving the contents data through the digital broadcast network, (a2) dividing the received contents data by broadcast channels, (a3) storing the divided contents data in a database, and (a4) transmitting the contents data stored in the database to a user through the internet network.

According to the present invention, the step of editing the contents data stored in the database is further comprised between the step (a3) and the step (a4).

The step (b) comprises the steps of receiving the contents data through the Internet network, dividing the received contents data into video data, audio data, and information data, decoding the divided video and audio data and interpreting the divided information data, and synchronizing the decoded video and audio data with the interpreted information data and outputting synchronized data.

There is provided a system for re-utilizing contents data for digital broadcasting, comprising a tuner for receiving a TS transmitted from a broadcasting station, a remultiplexer for dividing contents data from the received TS, a database for storing the divided contents data, a decoder for decoding the contents data stored in the database, a data editor for editing the decoded contents data, an encoder for encoding the edited contents data in order to transmit the encoded contents data to a viewer through an Internet network, and a user terminal for receiving the contents data through the Internet network and viewing the received contents data.

The user terminal comprises a receiver for receiving the TS formatted contents data through the Internet network, a demultiplexer for dividing the received contents data into the video data, the audio data, and the information data, a video data decoder for decoding the divided video data, an audio data decoder for decoding the divided audio data, an information data processor for decoding the divided information data and interpreting synchronizing information items between the information data and the video and audio data, a display controller for synchronizing the decoded video data with the information data in relation to the interpreted information data items and outputting the synchronized data on a screen, an audio controller for synchronizing the decoded audio data with the information data and outputting the synchronized data through a speaker, and a transmitter connected to the information data processor, the transmitter for receiving data from an input apparatus and transmitting the data through the Internet network.

### BRIEF DESCRIPTION OF THE DRAWINGS

The above object and other advantages of the present invention will become more apparent by describing preferred embodiments thereof in detail with reference to the attached drawings in which:

FIG. 1 is a schematic diagram describing a method for re-utilizing contents data for digital broadcasting and a system therefor according to the present invention;

FIG. 2 is a schematic diagram describing the structure of a server of FIG. 1 and processes of retransmitting the contents data by the server; and

FIG. 3 is a schematic diagram describing the structure of a user terminal of FIG. 1 and processes of outputting the contents data by the user terminal.

### DETAILED DESCRIPTION OF THE PREFERRED EMBODIMENTS

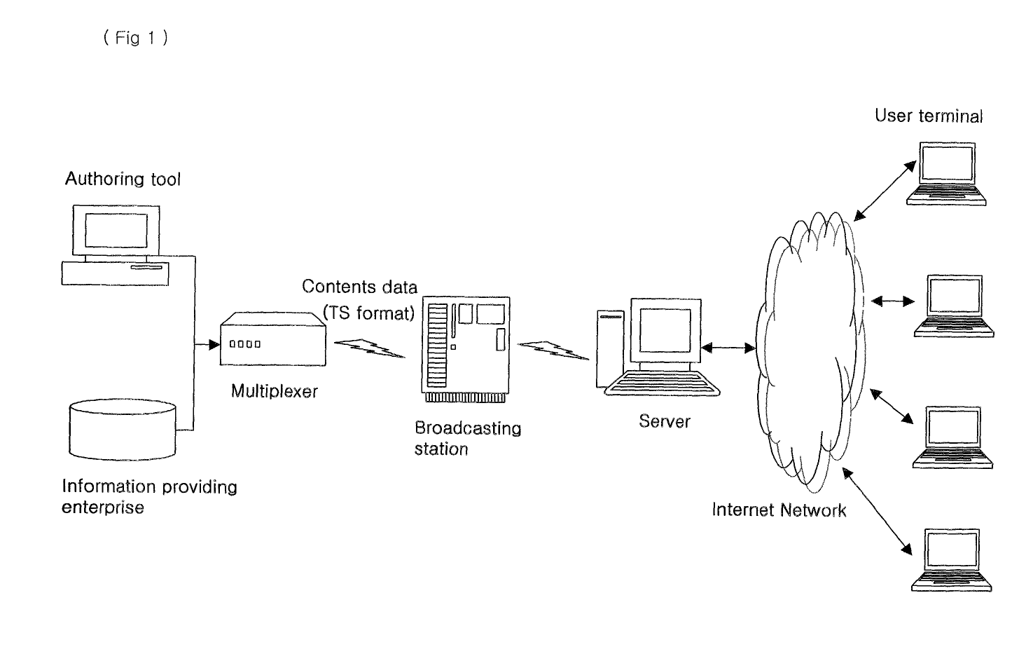

FIG. 1 is a schematic diagram showing a system for re-utilizing contents data for digital broadcasting according to the present invention.

In general, a digital broadcast program, in which video data, audio data, and information data including information related to the digital broadcast program are combined with each other, is provided to viewers. According to the present invention, the video data, the audio data, and the information data, which form the broadcast program, and broadcast program data including synchronizing information are referred to as contents data for digital broadcasting.

The contents data for digital broadcasting is created by creating the information data using program creating tools (authoring tools) and synchronizing the video and audio data related to the information data with each other. Thus created contents data for digital broadcasting is provided to the viewers through a broadcast system. In an embodiment of the present invention, as shown in FIG. 1, the contents data created by the authoring tools is formatted to a transmission stream (TS) for digital broadcasting by a multiplexer. The TS formatted contents data is digitally modulated by a broadcasting station, is transmitted to an airwave, and is received by a server.

The received contents data is stored in a database by the server and is distributed to users (viewers) who wish to view the program through an Internet network. The users can view the TS formatted digital broadcast program by connecting a TS browser or a viewing apparatus to a computer.

The reception of the contents data by the server, a method for processing the contents data by the viewers, and the structure of a system for processing the contents data by the viewers will now be described in detail.

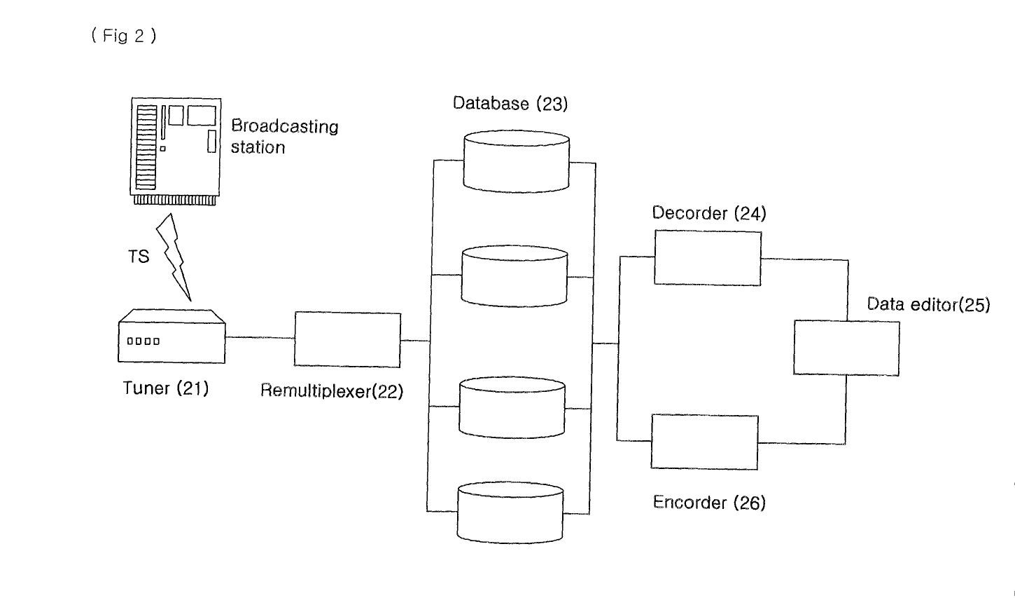

FIG. 2 is a schematic diagram showing the server of a system for re-utilizing the contents data for digital broadcasting according to the present invention.

The server 20 includes a tuner 21 for receiving the TS transmitted from the broadcasting station, a remultiplexer 22 for separating each contents data from the received TS, a database 23 for storing each separated contents data, a decoder 24 for decoding the contents data stored in the database 23, a data editor 25 for editing the decoded contents data, and an encoder 26 for encoding the edited contents data in order to transmit the contents data to the viewers.

The tuner 21 receives the TS for digital broadcasting transmitted from a digital broadcasting network. In general, the contents created by the contents authoring tools by the broadcasting station are encoded by a formatting method previously defined according to the schedule of the defined information data and are TS formatted. Also, it is possible to provide a multi-channel using a virtual channel during the transmission of the contents data. In order to simultaneously transmit the TS formatted contents data using the virtual channel, the contents data is multiplexed by the multiplexer and is transmitted through a plurality of channels. Thus transmitted contents data is received by tuning the channels by the tuner 21.

The TS received by the tuner 21 is divided by the remultiplexer 22 by broadcast channels. The remultiplexer 22 divides a plurality of virtual channels in a physical channel of the digital broadcasting system by channels in order to obtain the actual contents data for the digital broadcasting program.

Each divided TS is stored in the database 23 in the form of contents data.

The contents data divided by the remultiplexer 22 is stored in the database 23 in the form of the TS format by time zones or by broadcast programs.

When the broadcast program is divided by contents, each contents data must include the system information of the overlapping contents data. Also, the TS format received by the tuner 21 is maintained for the synchronizing information between the data included in the contents and the video and the audio data. The information data can be displayed on the television screens of the viewers at specific time according to the process of the broadcast program by the synchronizing information.

The contents data stored in the database 23 are edited by the data editor 25.

The edition by the data editor 25 is not essential. However, it is possible to improve the quality of the contents data provided to the users by TS formatting the contents data stored in the database 23 to be suitable for the conditions of the users by performing the edition. Either the entire contents or some of the contents can be edited. The edition of the contents includes the generation of new information data as well as the edition of some of the information data of the contents data. This is because the server uses the authoring tools for creating the contents data. The authoring tool can be realized to be similar to an authoring method by the authoring tool used to create original contents data. The source code of the contents data is necessary in order to modify the contents data. However, it is difficult for the broadcasting station to transmit the source code. In order to solve this problem, the contents data is edited as follows in the embodiment according to the present invention.

The contents data stored in the database 23 are decoded through the decoder 24.

As mentioned above, the contents data including the synchronizing information of the information data as well as the audio, video, and information data is stored in a state of being TS formatted. The synchronizing information includes information on a method for encoding Data Carousel that is a time schedule for periodically and repeatedly transmitting the contents data, an asynchronous Internet protocol (IP) stream used for transmitting related data on the Internet, a synchronous stream used for transmitting data including the synchronizing information, and a synchronized stream and information on a method for grouping a data module that is an aggregate of the data stream

Therefore, it is not desirable to directly edit the TS having a complicated structure using the authoring tool. Also, it is necessary to convert the format of the contents data in order to edit the contents data since the format of the contents data stored in the database 23 is the TS format when the contents data is transmitted. The format of the contents data is not converted into the TS format but a common stream format by decoding the contents data to be edited using the decoder 24 according to the present embodiment.

The converted contents data is edited by the data editor 25 using the contents authoring tools if necessary

The converted contents data is newly edited by the data editor 25. The authoring tools and the authoring method for the edition are realized using a well-known technology Therefore, detailed description of the authoring tools and the authoring method will be omitted.

The edited contents data is encoded using the encoder 26 and is stored in the database 23.

The format of the edited contents data must be maintained as the TS format that is the format during the initial transmission of the contents data when the edited contents data is transmitted to the users (the viewers). In order to achieve this, the edited contents data is TS formatted using the encoder 26 and is stored in the database 23.

The TS formatted contents data stored in the database 23 is provided to the users (the viewers) through the Internet network. The server according to a preferred embodiment of the present invention includes an interface for contacting the Internet network and a protocol processor for processing the TCP/IP protocol in order to transmit the edited contents data. The contents data is provided through the Internet network so as not to be restricted by time in viewing the contents data, not to search the broadcast programs, and to let the users (the viewers) easily utilize the contents through the Internet.

The user must install a program for viewing the content data, that is, a browser in the computer terminal of the user or a hardware display.

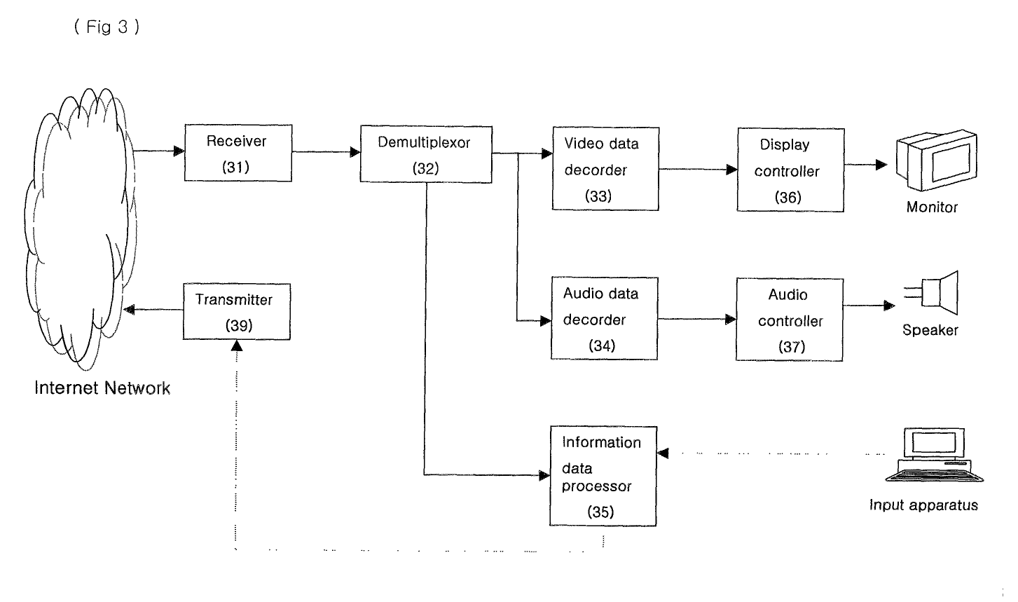

FIG. 3 is a schematic diagram showing the structure of a TS browser, that is, the computer terminal for viewing the contents data.

The TS browser includes a receiver 31 for receiving the TS formatted contents data transmitted from the Internet network, a demultiplexer 32 for dividing the received contents data into the video data, the audio data, and the information data, a video data decoder 33 for decoding the divided video data, an audio data decoder 34 for decoding the divided audio data, an information data processor 35 for decoding the divided information data and interpreting the synchronizing information items between the information data and the video and audio data, a display controller 36 for synchronizing the decoded video data with the information data in relation to the interpreted information data and outputting the synchronized data to the screen of the user, an audio controller 37 for synchronizing the decoded audio data with the information data and outputting a voice through a speaker, and a transmitter 39 connected to the information data processor 35, the transmitter 39 for receiving data from an input apparatus 38 and transmitting the data through the Internet network.

After the user (the viewer) contacts the server using the user terminal of FIG. 3, the user receives the contents data from the Internet network through the receiver 31.

The user contacts the server shown in FIG. 2 and receives the TS formatted contents data through the receiver 31.

The received contents data is divided into the video data, the audio data, and the information data through the demultiplexer 32. At this time, the data items can be divided using a well-known technology since the data items are previously formatted according to the characteristics of the data items.

The divided video and audio signals are decoded by the video data decoder 33 and the audio data decoder 34. The divided information data is interpreted by the information data processor 35.

The formats of the TSs of the video data and the audio data are interpreted by the video data decoder 33 and the audio data decoder 34.

The method, where the information data is decoded by the information data processor 35, can be the same as the decoding method in the process of editing the information data by the server. At this time, the synchronizing information items between the information data and the video and audio data such as Data Carousel, an asynchronous Internet protocol stream, a synchronous stream, and a synchronized stream of the information data are interpreted.

In the divided video data, the information items of the TS are interpreted through the video data decoder 33. The display controller 36 synchronizes the data information processed by the information data processor 35 with the interpreted video data and displays the synchronized data on a monitor. In the divided audio data, the information items of the data are interpreted through the audio data decoder 34. The audio controller 37 synchronizes the interpreted audio data with the information data and outputs the synchronized data through the speaker.

The data including the requirements of the user or the information on the user is input to the information data processor 35 through the input apparatus of the computer terminal of the user such as a mouse or a keyboard. The input data is transmitted to the server using the Internet network. Predetermined processing is performed by the server according to the information transmitted from the user terminal.

A method for re-utilizing the contents data for digital broadcasting, which is performed by a system for re-utilizing the contents data for digital broadcasting according to the present invention of the above structure, will now be described.

The method for re-utilizing the contents data for digital broadcasting includes the steps of receiving the contents data from a digital broadcasting network and editing the received contents data and receiving the edited contents data through the Internet network and viewing the received contents data.

The step of receiving and editing the contents data is performed by the server and includes the steps of receiving the contents data through the digital broadcasting network, dividing the received contents data by broadcasting channels, storing the divided contents data in a database, editing the contents data stored in the database, and transmitting the edited contents data to the user through the Internet network.

In the step of receiving the contents data, the contents data for digital broadcasting transmitted from the broadcasting station through the digital broadcasting network is received by the tuner 21. In the step of dividing the contents data, the plurality of virtual channels of the received contents data are divided by the remultiplexer 22 by channels. Thus divided contents data is stored in the database 23. Before storing the contents data in the database 23, the contents data is TS formatted by the remultiplexer 22 and is stored in the database 23 by time zones of the contents data and the digital broadcast programs.

In the step of editing the contents data, the TS formatted contents data stored in the database 23 is processed to be suitable for the conditions of the user by the operator of the server. It is possible to improve the quality of the contents data provided to the user through the edition step.

The step of editing the contents data includes the steps of decoding the contents data stored in the database, editing the decoded contents data, and encoding the edited contents data and storing the encoded contents data in the database.

In the step of decoding the contents data, the contents data to be edited is decoded by the decoder 24 and the format of the contents data is not converted into the TS format but the common stream format. The edition step is performed by the data editor 25. The authoring tool and the authoring method for editing the contents data can be realized using the well-known technology. The edited contents data is TS formatted by the encoder 26 in order to be transmitted to the user and is stored in the database 23.

The contents data is transmitted through the protocol processor of the server. The user can view the contents data at desired time, needs not search the broadcast program, and can utilize the contents data to be suitable for the object and the environment of the user by transmitting the contents data to the user (the viewer) through the internet network.

The step of viewing the contents data includes the steps of receiving the contents data through the Internet network, dividing the received contents data into the video data, the audio data, and the information data, decoding the divided video and audio data and interpreting the divided information data, and synchronizing the decoded video and audio data with the interpreted information data and outputting the synchronized data.

In the step of receiving the contents data through the Internet network, the user contacts the server through the Internet using the computer terminal of the user and receives the desired TS formatted contents data by the receiver 3 1. The received contents data is divided into the video data, the audio data, and the information data by the demultiplexer 32. The video and audio data divided in the step of dividing the contents data is decoded by the video data decoder 33 and the audio data decoder 34. The divided information data is interpreted by the information data processor 35. The video data interpreted in the interpretation step is displayed on the monitor of the user terminal by the display controller 36. The interpreted audio data is output by the audio controller 37 by the speaker.

In the method for re-utilizing the contents data for digital broadcasting according to the present invention, the user can operate the server as well as can view the contents data by contacting the server. Fields where the user can operate the server include an education field, an Internet broadcast field, and public relations and advertisement fields of enterprises. In particular, in the case of the education field, students can contact desired servers at desired time, to thus study according to their own intellectual levels since the contents for education can be stored in the server by subjects and can be converted into new contents for education through appropriate edition. Students can create materials of their own using the contents. Also, the materials can be easily exchanged between educators and educated people through the Internet.

According to the present invention, it is possible to easily obtain and process contents of a specific field desired by the users in an Internet broadcast.

Enterprises can reduce public relations and advertisement expenses by easily obtaining and processing materials such as materials related to the enterprises, materials for public relations, and special contents by departments.

According to the present invention, it is possible to reduce expenses spent on creating information contents and to obtain and re-process various contents in reproducing and processing the information.

Also, it is possible to actively utilize the contents since it is possible to store and re-edit the contents data for one-time broadcasting.

While this invention has been particularly shown and described with reference to preferred embodiments thereof, it will be understood by those skilled in the art that various changes in form and details may be made therein without departing from the spirit and scope of the invention as defined by the appended claims.

What is claimed is:

1. A method for re-utilizing contents data for digital broadcasting, comprising the steps of:
(a) receiving and editing contents data from a digital broadcast network; and
(b) receiving the edited contents data through an Internet network and viewing the received contents data.

2. The method of claim 1, wherein the step (a) comprises the steps of:
(a1) receiving the contents data through the digital broadcast network;
(a2) dividing the received contents data by broadcast channels;
(a3) storing the divided contents data in a database; and
(a4) transmitting the contents data stored in the database to a user through the Internet network.

3. The method of claim 2, further comprising the step of editing the contents data stored in the database between the step (a3) and the step (a4).

4. The method of claim 3, wherein the step of editing data comprises the steps of:
decoding the contents data stored in the database;
editing the decoded contents data; and
encoding the edited contents data and storing the encoded contents data in the database.

5. The method of claim 1, wherein the step (b) comprises the steps of:
receiving the contents data through the Internet network;
dividing the received contents data into video data, audio data, and information data;
decoding the divided video and audio data and interpreting the divided information data; and
synchronizing the decoded video and audio data with the interpreted information data and outputting synchronized data.

6. The method of claim 2 or 5, wherein the format of the contents data is a transmission stream (TS).

7. A system for re-utilizing contents data for digital broadcasting, comprising:
a tuner for receiving a TS transmitted from a broadcasting station;
a remultiplexer for dividing contents data from the received TS;
a database for storing the divided contents data;
a decoder for decoding the contents data stored in the database;
a data editor for editing the decoded contents data;
an encoder for encoding the edited contents data in order to transmit the encoded contents data to a viewer through an internet network; and
a user terminal for receiving the contents data through the Internet network and viewing the received contents data.

8. The system of claim 7, wherein the user terminal comprises:
a receiver for receiving the TS formatted contents data through the Internet network;
a demultiplexer for dividing the received contents data into the video data, the audio data, and the information data;
a video data decoder for decoding the divided video data;
an audio data decoder for decoding the divided audio data;
an information data processor for decoding the divided information data and interpreting synchronizing information items between the information data and the video and audio data;
a display controller for synchronizing the decoded video data with the information data in relation to the interpreted information data items and outputting the synchronized data on a screen;
an audio controller for synchronizing the decoded audio data with the information data and outputting the synchronized data through a speaker; and
a transmitter connected to the information data processor, the transmitter for receiving data from an input apparatus and transmitting the data through the Internet network.
